(19) United States
(12) Patent Application Publication
(10) Pub. No.: US 2025/0146269 A1
(43) Pub. Date: May 8, 2025

(54) CONSTRUCTION EVALUATION AND PRODUCTION SYSTEM AND METHODS OF USE THEREFOR

(71) Applicant: Resia IP Holding, LLC, Miami, FL (US)

(72) Inventors: Ernesto Lopes, Miami, FL (US); Selma Rabelo, Miami, FL (US)

(73) Assignee: Resia IP Holding, LLC, Miami, FL (US)

(21) Appl. No.: 18/934,911

(22) Filed: Nov. 1, 2024

Related U.S. Application Data
(60) Provisional application No. 63/547,263, filed on Nov. 3, 2023.

(51) Int. Cl. E04B 1/348; G06Q 50/08

(52) U.S. Cl. CPC E04B 1/34869; E04B 1/34823; G06Q 50/08

(57) ABSTRACT

A construction evaluation and production system and methods of use therefor are disclosed. The method can create test fits for site plans for parcels of land and floor plans for one or more buildings. The method utilizes a plurality of building blocks, which are poured in concrete using metal forms, and prefabricated structures that can be easily transported into the building blocks to facilitate construction of apartment units and common areas comprising such building blocks. The method enables efficient and accelerated construction.

### STATEMENT OF RELATED CASE

The instant application claims the benefit of commonly owned, prior provisional application No. 63/547,263 filed on Nov. 3, 2023 and titled “Construction Production System and Methods of Use Therefor”, the entirety of which is hereby incorporated by reference.

### FIELD OF THE INVENTION

The present invention relates generally to real estate evaluation and production, assembly and installation of commercial and residential construction structures. With respect to evaluation, the present invention relates generally to the design, development, specifications, and overall objectives and means and methods of real estate evaluation technologies, and in a particular though non-limiting embodiment, to the design, development and means and methods of identifying real estate upon which to build. The present invention is also directed to production, assembly and installation of commercial and residential construction structures, and in a particular though non-limiting embodiment, to the design, development, specifications, and overall objectives and means and methods of a modularized new development construction method that reduces costs, risks, and the construction production lifecycle. Development of sophisticated analytics, for example, artificial intelligence and machine learning are also provided. In one detailed though non-limiting embodiment, modular structures are created using a plurality of pre-treated, fire-retardant construction panels in conjunction with a suite of sophisticated robotics, software tools, artificial intelligence, and detailed construction planning aspects unknown elsewhere in the industry. Ordinarily skilled artisans will readily appreciate, however, that a great many other modular and/or alternative structures are suitable for use with the systems and methods disclosed herein within the scope of the instant specification.

### BACKGROUND OF THE INVENTION

Strong communities tend to share certain common characteristics, for example, access to high-quality schools, transportation systems, employment opportunities, and recreation and entertainment facilities. Meanwhile, a severe housing shortage has arisen across the country that impairs the development of such communities, attributable primarily to a combination of financial factors, materials shortages, and a declining skilled labor force.

Builders have therefore been seeking solutions to these shortages in an effort to provide quality, affordable housing on a more time- and cost-effective basis. In particular, builders have found that by incorporating certain pre-fabricated components off-site, materials can be concentrated in locations established for centralized production, and fewer personnel are required to assemble the components for delivery to one or more construction sites.

However, the current prefabrication model is plagued by inefficiencies, safety concerns, personnel requirements, and questionable building practices and materials, especially during set up and installation.

For example, in certain off-site construction methods, prefabricated structures such as kitchens and bathrooms are constructed using standard drywall and steel studs to form the walls and ceilings of the structures, essentially mirroring the procedures employed at the construction sites, though assembly is remotely performed prior to the structures delivery to the job sites. The modules resulting from this approach tend to be large, bulky, heavy frameworks and rough precuts, and tend to vary so much from one another that true modularization and standardization are not achieved. For example, a modular housing system is described in U.S. Pat. No. 10,704,251 that uses a plurality of prefabricated system modules that are vertically aligned with each other and joined with a fastener assembly. However, such systems are deficient for the reasons described herein. Moreover, other modular units' ultimate installation is virtually always flawed and uncoordinated rather than seamless and integrated throughout, as would be far more efficient, even though maximum efficiencies should be realized at every step throughout the process in order to significantly improve the installation and assembly process.

In stark contrast, the innovative, unique and proprietary real estate evaluation and construction methods and systems disclosed herein enables builders to efficiently shorten the real estate development cycle and deliver well-appointed communities with affordable rents, designed in most instances to serve the American workforce specifically, though the disclosed systems and methods are not limited to such applications.

### SUMMARY OF THE INVENTION

A construction evaluation and production system and methods of use therefor are provided. In accordance with some embodiments of the disclosed subject matter, a method of real estate development and building construction is provided, the method comprising: selecting a parcel of land; running a financial analysis of the project and creating a site plan for one or more buildings on the parcel of land by generating a test-fit of the location, using footprint, and number of floors of the one or more buildings; creating a floor plan for the one or more buildings comprised of at least a first building block and a second building block, wherein each said building block comprises at least one apartment and at least one common area; providing a first prefabricated structure comprising a plumbing or electrical component for the first building block; providing a second prefabricated structure comprising a plumbing or electrical component for the second building block; providing a first metal form corresponding to the first building block at a location corresponding to the first building block on the site plan and the floor plan; pouring concrete in the first metal form to create the first building block; removing the first metal form; transporting the first prefabricated structure through an opening in the first building block and into a location corresponding to the floor plan; connecting the plumbing or electrical component of the first prefabricated structure to a plumbing or electrical component of the first building block; providing a second metal form corresponding to the second building block at a location corresponding to the second building block on the site plan and floor plan; pouring concrete in the second metal form to create the second building block; removing the second metal form; transporting the second prefabricated structure through an opening in the second building block and into a location corresponding to the floor plan; and connecting the plumbing or electrical component of the second prefabricated structure to a plumbing or electrical component of the second building block. In some embodiments, prefabricated structures may be selected from the group consisting of: a bathroom, a kitchen, prefabricated interior walls, a bedroom, a closet, a mechanical system, an electrical system, a fire protection system, a sanitation unit, a plumbing system, and a drainage system. In some embodiments, a building block comprises at least four areas, such as three apartments and a common area, such as a corridor, common room, or a stairwell. In some embodiments, two or more building blocks make up a building plate, which can correspond to a single floor of a building. The method may ensure a streamlined and efficient construction process, allowing for faster assembly and completion of the building.

### BRIEF DESCRIPTION OF THE DRAWINGS

The present disclosure can be better understood by reference to the accompanying drawings, in which:

FIG. 1 is a diagram of a real estate evaluation and production system workflow;

FIG. 2 is view of one embodiment of a building block comprising four apartments connected by a central corridor;

FIG. 3 is an illustration of various test fits for builds on a software platform;

FIG. 4 is an illustration of variables within a test fit considered on a software platform;

FIG. 5A is an illustration of building information modeling on a software platform;

FIG. 5B is an illustration of floorplan variables modeling on a software platform;

FIG. 6 is an illustration of standard apartment modeling on a software platform;

FIG. 7 is an illustration of line of balance project management and scheduling on a software platform;

FIG. 8A is a diagram of examples of standardized and modularized building components such as prefabricated structures comprising a closet, modular shelves, interior wall, bathroom and a kitchen;

FIG. 8B is a diagram illustrating an embodiment of building construction with a prefabricated metal rack that carries mechanical, electrical, plumbing, and fire systems pre-assembled for corridors and common areas; and

FIG. 9 is a diagram illustrating an embodiment of pour in place concrete shell building with metal forms.

### DETAILED DESCRIPTION OF THE INVENTION AND EMBODIMENTS

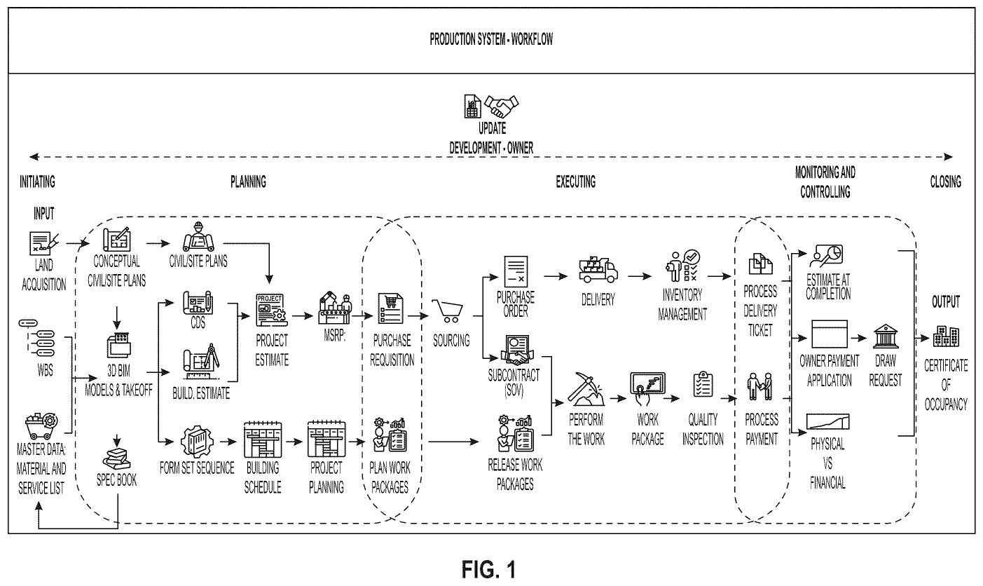

In real estate development, optimizing building combinations to maximize yield while adhering to necessary commercial constraints is a complex problem. Traditional methods have previously relied upon manual calculations and/or heuristic approaches, which does not guarantee an optimal solution or can consume a great deal of time. The present invention provides a novel system and method for avoiding the shortcomings of the prior art. In one example embodiment, a tool designed to facilitate land evaluation, acquisition, development, and construction is provided. It further provides project tracking processes during development and construction. FIG. 1 shows one embodiment of a real estate evaluation and production system workflow from initiation of site evaluation through receipt of a certificate of occupancy.

Through the platform, a user is provided a visual representation of properties analyzed and/or acquired by a builder, as well as details regarding available areas and/or the current status of the builder's portfolio. The simulator tool is designed to generate optimal building combinations for a property by dynamically leveraging the aforementioned collection data and, in some embodiments, considers various parameters such as building yield on cost and constraints on unit percentages to determine the most profitable combinations of buildings. It also allows users to simulate other scenarios, changing costs and rents, calculating financial results in real time and displaying them, side by side with the original financial results.

In one embodiment, projects are color-coded, providing immediate visual cues about their status. According to certain example functions, it is possible to see information regarding comparable real estate in the relevant area. For example, in a specific example embodiment the closest comparable properties within a defined radius, for example three miles, are identified, and basic information about unit types, the number of units, and associated rents, for example, along with the possibility of being directed to the property's website are provided.

Another feature is that integration with an artificial intelligence (hereafter “AI”) engine is provided. Through the connection with a user's database, the chat offers quick and direct responses, providing crucial information about financial indicators, dates, detailed project characteristics, and more.

For example, a user can search by a contemplated deal specifically, or a desired parcel address. In this manner, various information is displayed, for example, including lot numbers, property details, and land use specifics. The tool also offers suggested rents, derived from calculations based on average income data within the defined radius of interrogation.

In another embodiment, the system comprises publicly available census data, which constitutes a comprehensive data repository covering occupied and unoccupied housing units, average income, and population statistics.

In other embodiments, tools highlight key points of interest located within the radius as defined by the user.

In further embodiments, a user can also analyze supply and demand dynamics, for example, providing an understanding of regional behavior from, for example, 2020 to 2029. This strategic vision is instrumental in making informed decisions, especially when selecting desired lots. The tool further enhances its utility by offering insights into effective rents and occupancy trends per year, facilitating decisions based on leasing strategies.

From here, a simulation tool automatically loaded with geographic information is provided. In one embodiment, the address, parcel identification number, city, and land area are populated, and a new project begins. In a further embodiment, a next step involves provision of more detailed information about the project, such as the number of floors to be considered, the maximum number of units allowed, land value, types and the costs of parking, and extra costs associated with the property are provided.

Such values influence the cost analysis that the platform generates at the end of the study. In one embodiment, rent values based on the region's income analysis are used as an initial filter, or edited as needed. At the end of these steps, the platform provides a first financial analysis of a property plus construction setting, generating the best combination of buildings for the selected project. If the provided combination is still not the most suitable for the land format, it is possible to choose from millions of other possible combinations of buildings, together with corresponding financial indicators.

Armed with information to produce a site plan, a test fit can be applied. With the address given in the first phase of the analysis, it is possible to find exactly the land that will be studied. In one embodiment, by clicking on a link tied to the property, the tool provides setbacks and standard zoning parameters for the region that can be adjusted if necessary. In a further embodiment, an associated library of commonly owned user properties is accessed, and a potential implementation is provided as a suggestion. In one embodiment, a user selects the same buildings previously provided by the simulator. In such manner, the appropriate buildings are identified, and the tool employs analytics to position them in the best location, adjust the number of floors, etc. From there, it is possible to consider the best implementation while considering the buildings available, the project's parking spaces, land access, and the availability of the amenities available on the platform. In one example embodiment, a site plan implementation is created, available in either (or both) 2D or 3D and integrated with previously obtained analytic data. After confirming in a test fit that the best building combination fits within the land, a user returns to the simulator to finalize a feasibility analysis.

In this stage, it is possible to edit calculated parameters, add necessary extra costs, and adjust rent values to visualize new financial results, which are automatically calculated after each adjustment. At the end of the simulation, a complete feasibility report is generated, allowing a user to export and analyze all available financial indicators.

In a further embodiment, a system comprising a mapping function, a financial calculator, and a field simulator can be combined to comprise an integrated software solution designed with a strong focus on geospatial functionalities, investment analysis, and field simulation. Built with a modern approach, the system adheres to a multi-layer architectural style, ensuring a clear separation between processing logic, data presentation, and information persistence.

In one embodiment, a cloud-based relational database offering high availability, security, and compatibility with an associated server is provided, thereby providing a reliable and secure operational environment.

In another embodiment, a framework for efficient and scalable building user interfaces is provided, thereby ensuring a fluid and responsive user experience, which can prove essential for interacting with the geospatial and simulation functionalities the system offers.

In summary, the system provides an advanced platform that combines leading market technologies to offer a powerful and integrated solution for geospatial analyses, field simulations, and investment analysis, designed to be highly scalable, secure, and easy to integrate with other solutions or services.

The tool facilitates land acquisition processes and monitors projects in development and under construction. Through the platform, a user gains a visual representation of all the lands analyzed by the offeror, as well as details about available areas and/or the current status of the offeror's property portfolio.

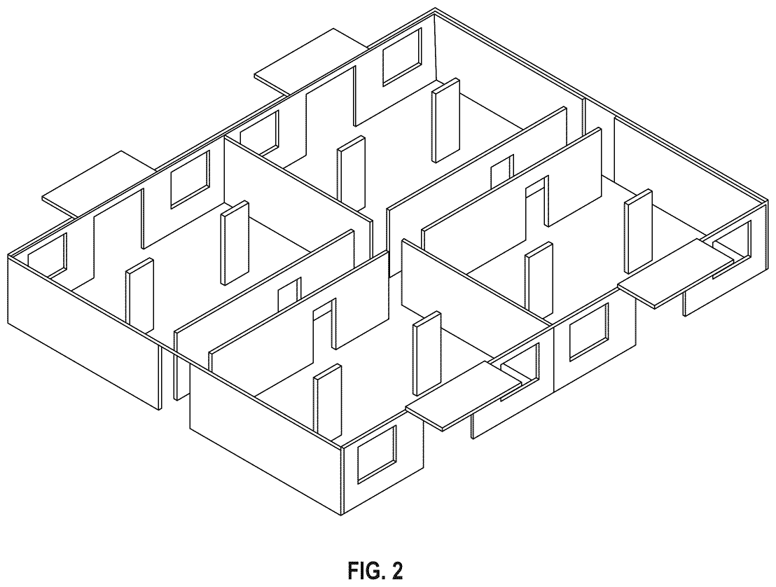

As illustrated in FIG. 2, a foundation of the disclosed construction production system comprises one or more fundamental building blocks. In one embodiment, the structures comprise a plurality of modular, standardized and/or customizable flexible floor plan designs.

For example, in one specific though non-limiting embodiment, a central module houses one or more of a kitchen, a living room, and a balcony. In another embodiment, a primary bedroom module comprises one or more of a primary bedroom, a closet, and a bathroom. In a further embodiment, a second bedroom module comprises one or more of a bedroom, a small closet, a utility closet, and a two-door bathroom. Ordinarily skilled artisans will recognize, however, that a virtually limitless number other packages, features, floor plans and design elements can be added, omitted or modified with equal efficacy.

Using these modules in various combinations (or nearly so), the instant system and methods offer at least three different types of residential unit floor plans, thereby catering to the diverse needs of literally countless designs associated with creative builders and buyers. In such manner, modularity and standardization of the construction components becomes not only possible, but the lynchpin of the new construction methods disclosed herein, thereby emphasizing efficiency at every step in the building process.

As illustrated in FIG. 2, each structure comprises a plurality of such building blocks, which in one embodiment further comprises a plurality of apartments connected by a central corridor. In a specific though non-limiting embodiment, said plurality of apartments further comprises four apartments connected by a central corridor. In one embodiment, a building block can comprise four apartments and related common areas, such as corridors. The design may also include alternative building block configurations, including components such as stairs, an elevator core, and/or technical areas like electrical rooms, pump rooms, and trash rooms. A specific building block called the “corner building block” may be used in some embodiments. A corner building block comprises preferably three apartments, elevators, corridors, and technical rooms, designed specifically for assembling “L” or “U” shaped buildings. By combining at least three apartment-only building blocks with stairs and an elevator core, a smaller building plate (or floor plan) is created. One possible configuration can accommodate up to 42 units per floor, though it is not limited to that number, and corresponds to a single floor of a building.

Ordinarily skilled artisans will appreciate, however, that greater or fewer numbers of units, common areas, and their specific configurations will vary without departure from the scope of the instant disclosure.

Similarly, pre-defined rules regarding design choices can be built into the modeling assumptions. For example, a set of predefined rules may comprise one or more of a plurality of practical considerations, e.g., ensuring that stair modules are connected to corner units, whether to use a plurality of similar designs in a column or row, where to install expansion joints, draining and fire considerations, etc.

In another embodiment, the building blocks come in a variety of configurations, e.g., one-bedroom, two-bedroom, and three-bedroom residential units are assembled and installed. In one embodiment, blocks using various combinations of pairs of apartment types enable the builder to treat them like modular pieces to build still larger structures called building plates, which in some embodiments can comprise one floor of a building.

After the building plates are defined, one determines the optimal number of floors for each building, keeping in mind site-specific characteristics such as density, setbacks, topography, zoning restrictions, drainage and other factors deemed relevant to the site.

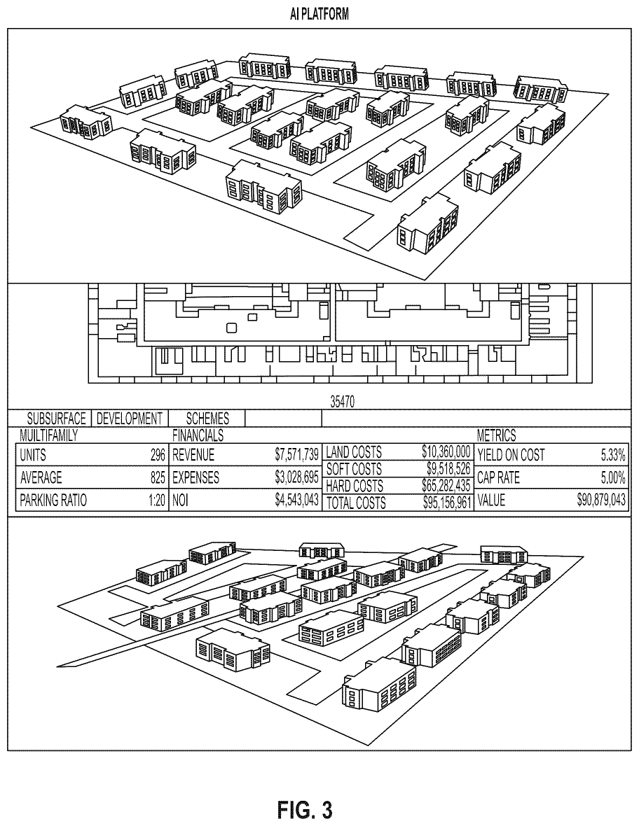

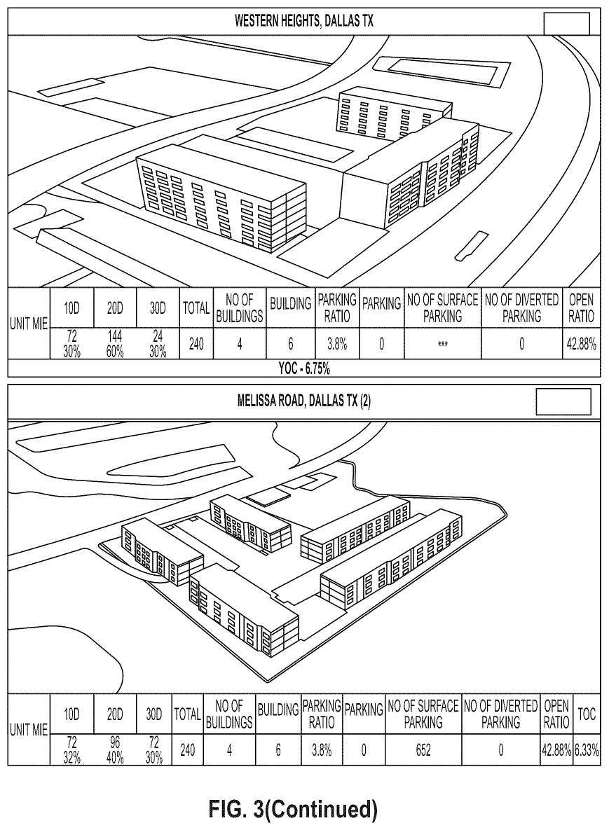

As seen in FIG. 3, in order to pre-plan a site plan with as much precision and creativity as possible, a test fit software platform is used to determine the best mix of unit types, layouts, and types of buildings for each specific site. In one embodiment, the planning tool runs hundreds of simulations within moments to ascertain site viability.

The powerful combination of artificial intelligence, machine learning, informed programming, and rapid inclusion of all factors known to be relevant to a new build allows for a reduction of time on site analysis; creation of satisfactory parking schemes; input for proprietary builder information concerning contemplated building structures and materials; and creation of an audit record to ensure code compliance at each step of the design process. In one embodiment, the Resia Pulse™ mapping tool and the Resia Simulator™ financial underwriting tool can be used to achieve these advantages.

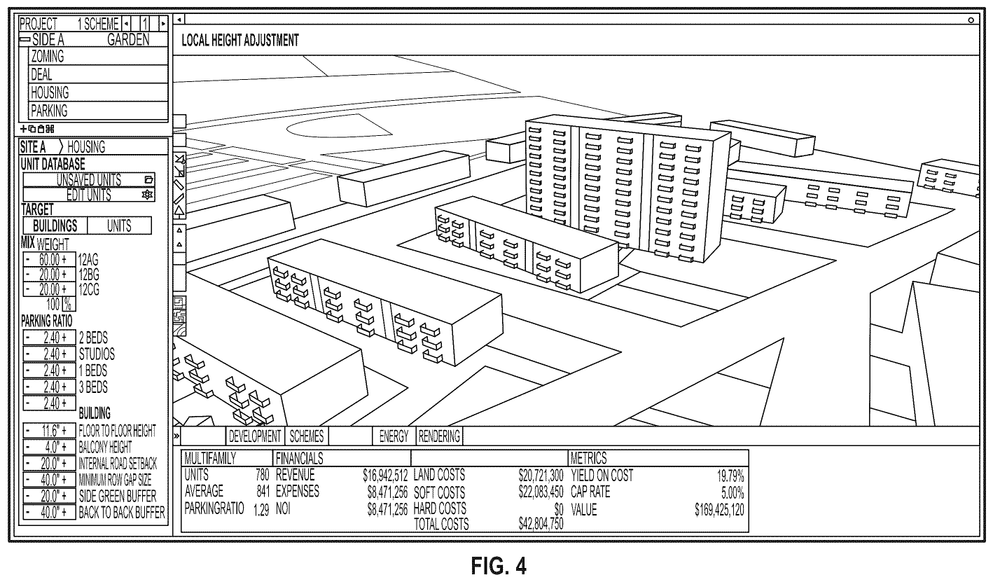

As seen in FIG. 4, the system also takes into account many deal-specific variables such as the purchaser's price constraints, compliance with community standards regarding building heights and the number of floors that may be constructed, and output of final design parameters in a suitable architectural design software platform ensures maximum project flexibility and reliability.

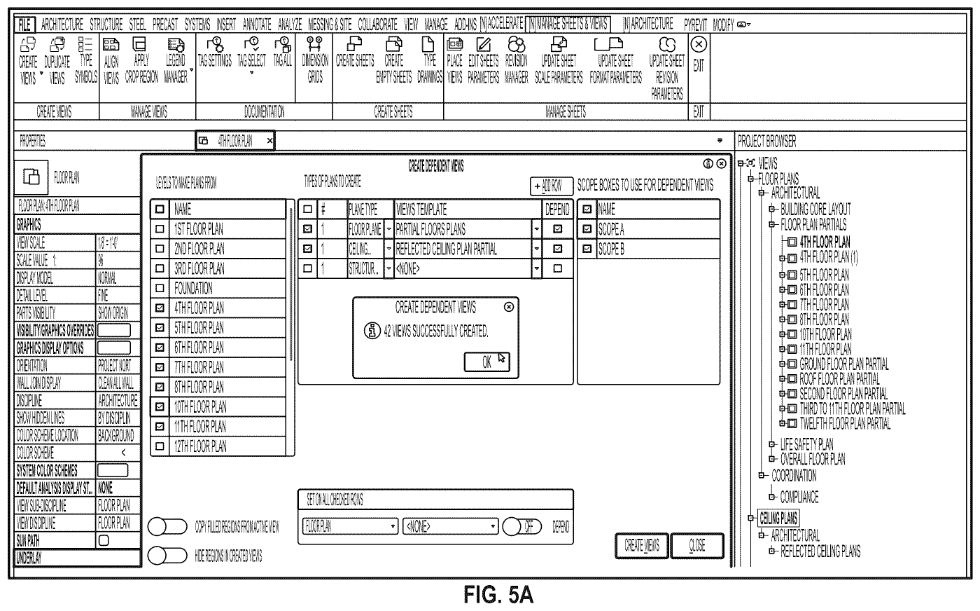

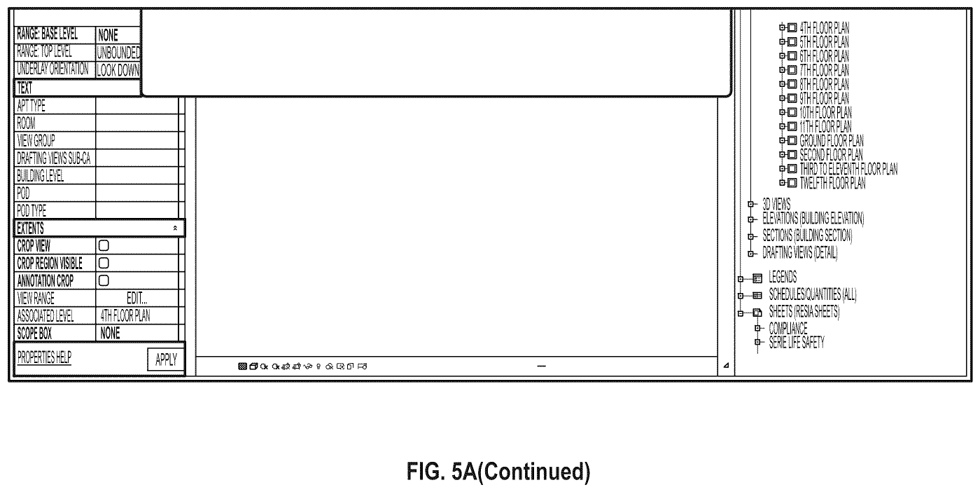

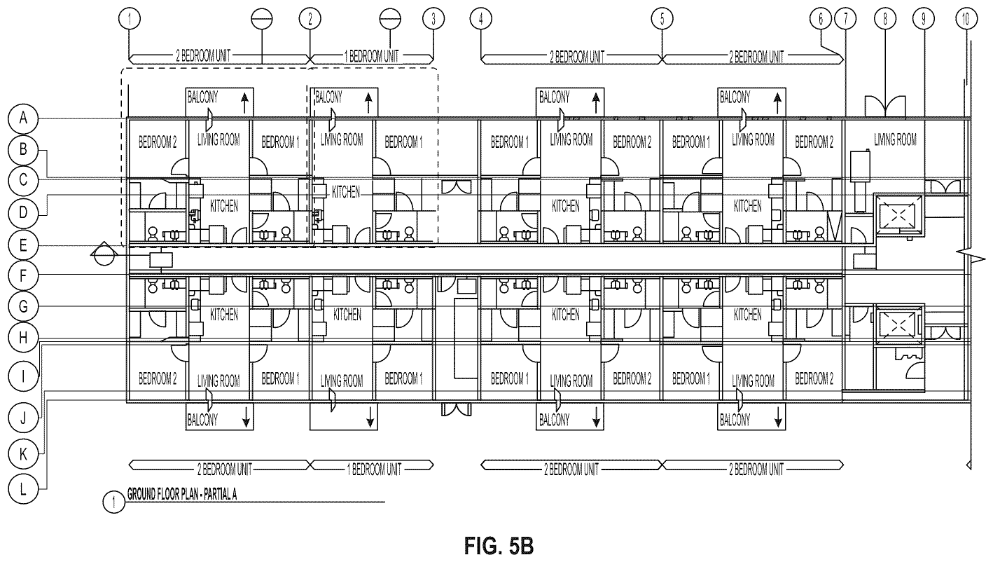

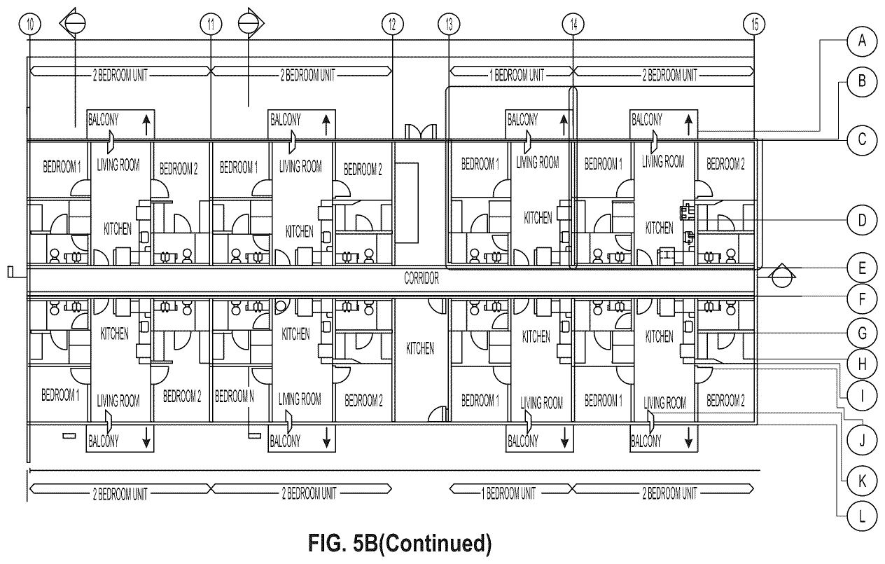

As seen in FIG. 5, in one embodiment, for example, a building information modeling software package is used by architects, engineers, and builders to create a unified 3D model that all disciplines and trades can use to complete their work. In other embodiments, such technology is applied to pre-design each of building blocks of the present disclosure. This process identifies and resolves all potential conflicts to avoid design errors, and helps generate a more reliable cost estimate for each building block.

As seen in FIG. 5, in one embodiment, by means of further software development, construction floorplans are created quickly and with only minimal errors, thereby reducing soft costs and development time. For example, the systems and methods disclosed herein accurately and automatically quantify the materials required for construction, thereby enabling estimators to quickly and easily navigate through the model and identify the required quantities of materials accurately. In one embodiment, the Resia Studio™ comprehensive digital platform that can create a 3D model and construction documents and automate scheduling for the specific buildings and specification book linked to the originated 3D model.

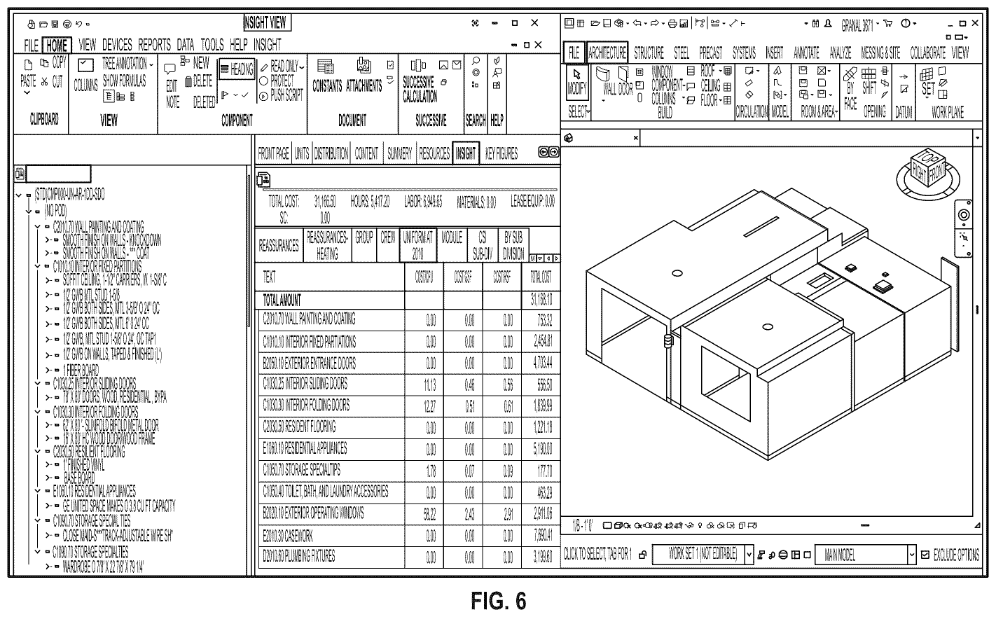

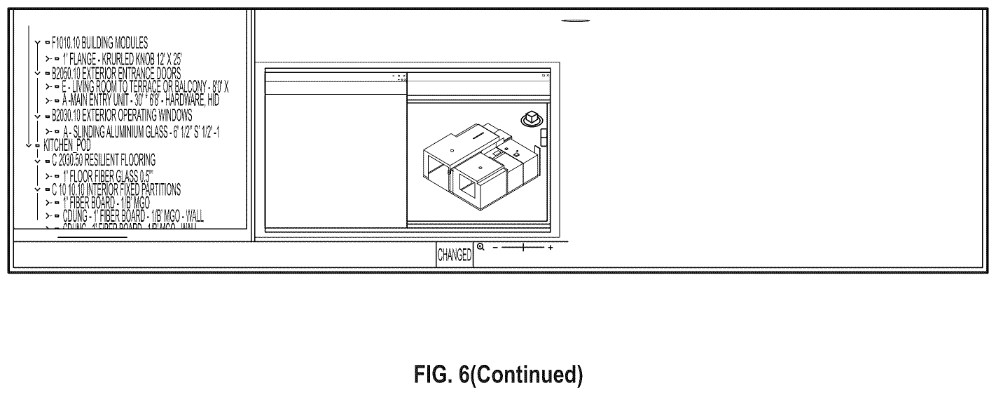

As seen in FIG. 6, a further aspect of the invention may lend efficiency and precision to cost estimation. Such automation supports cost optimization and improves collaboration, leveraging historical data to inform future projects. By harnessing the power of integration of various software solutions, more reliable and efficient cost estimation practices are achieved. In one embodiment, changes to relevant parameters are entered and integrated in real time, and again the system runs hundreds of possible permutations in mere seconds to achieve the best modelling.

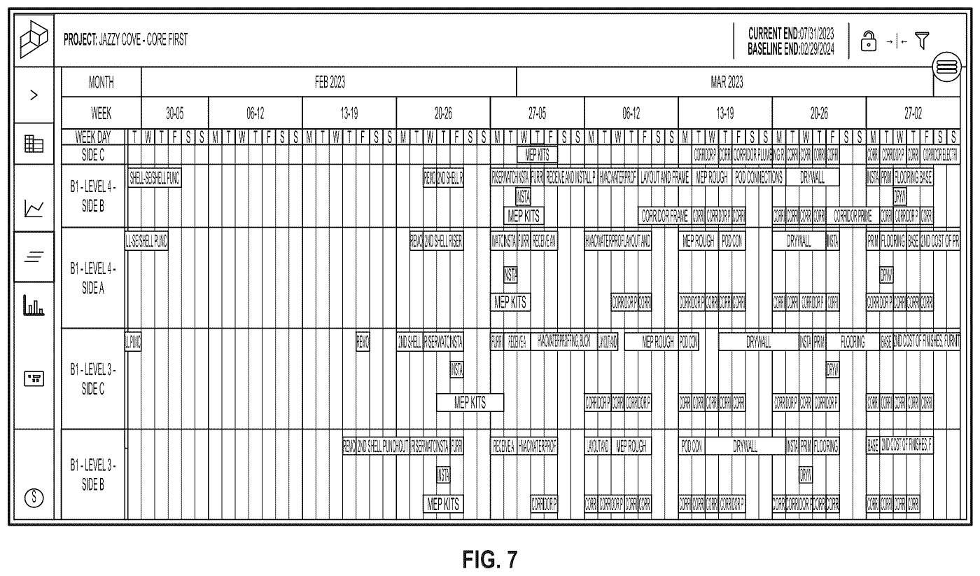

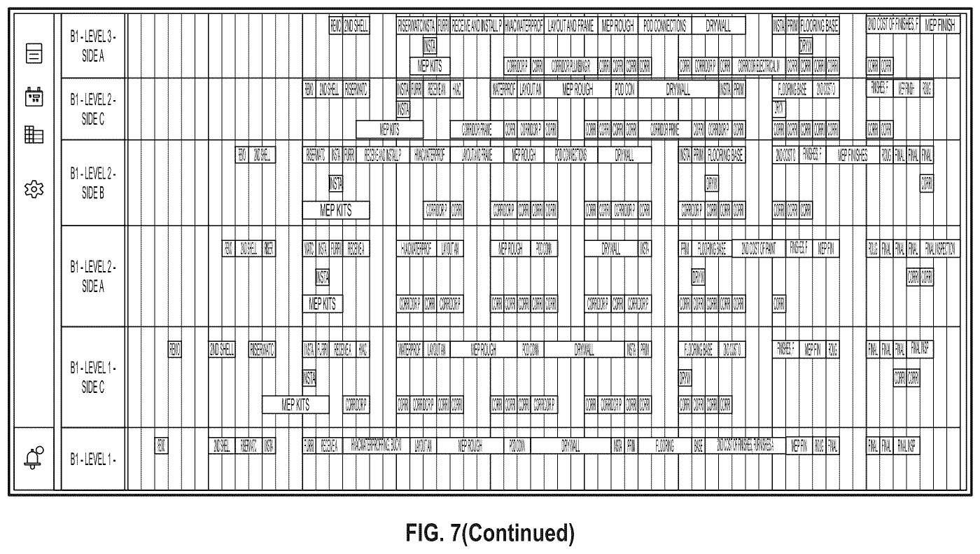

As seen in FIG. 7, one embodiment disclosed herein enables a lean line of balance approach to project management. Pre-designing as much as possible and then using project management planning solutions to optimize scheduling maintains a continuous workflow, which is ideal for repetitive tasks, thereby leading to significant productivity gains and cycle time reduction.

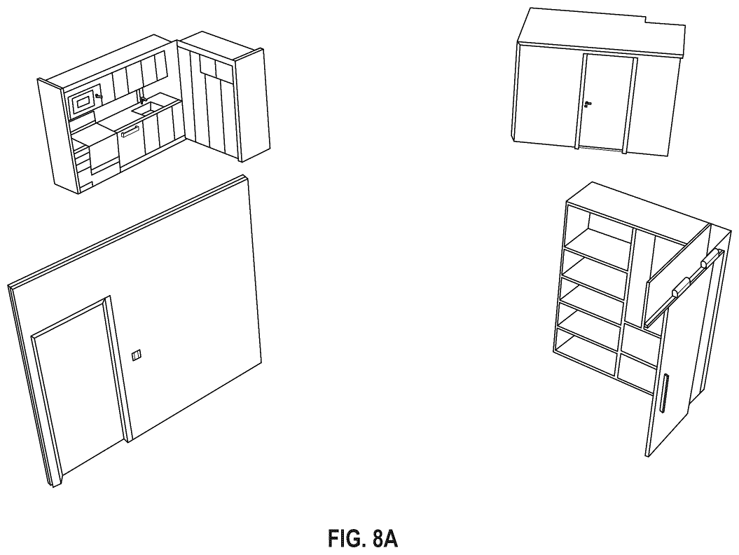

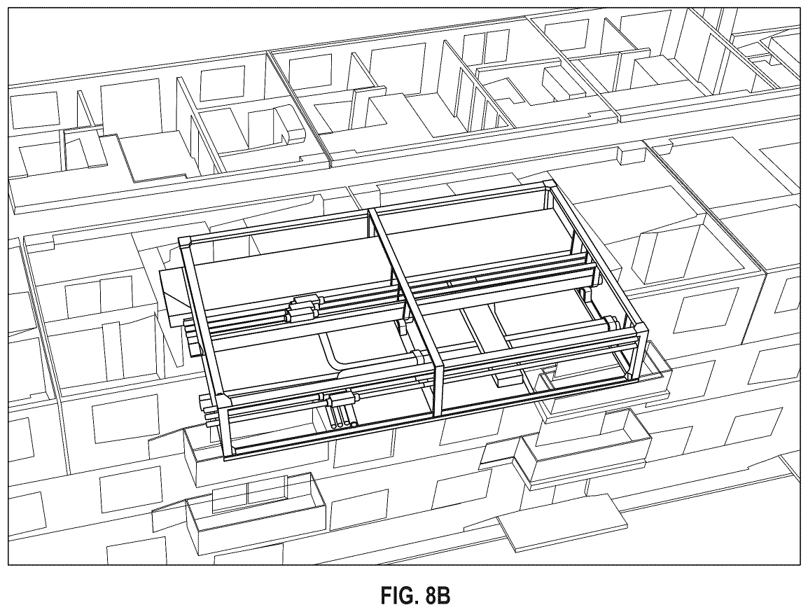

As seen in FIG. 8, standardized and modular building practices and parts allow for manufacture of common components and prefabricated structures like bathrooms, kitchens, prefabricated interior walls, and utility closets off-site, essentially transforming a construction site into an assembly line. According to another aspect of the invention, associated peripherals for the foregoing are built or otherwise acquired off-site, and then installed as needed for the specific demands of the application. Examples include, but are not limited to, mechanical and electrical components, fire protection, sanitation units, plumbing and drainage, etc. Panels and walls for such structures may be constructed in accordance with the systems and methods disclosed in U.S. patent application Ser. No. 18/827,227 entitled Systems and Methods for Construction Panel Production, the contents of which are hereby incorporated by reference in their entirety.

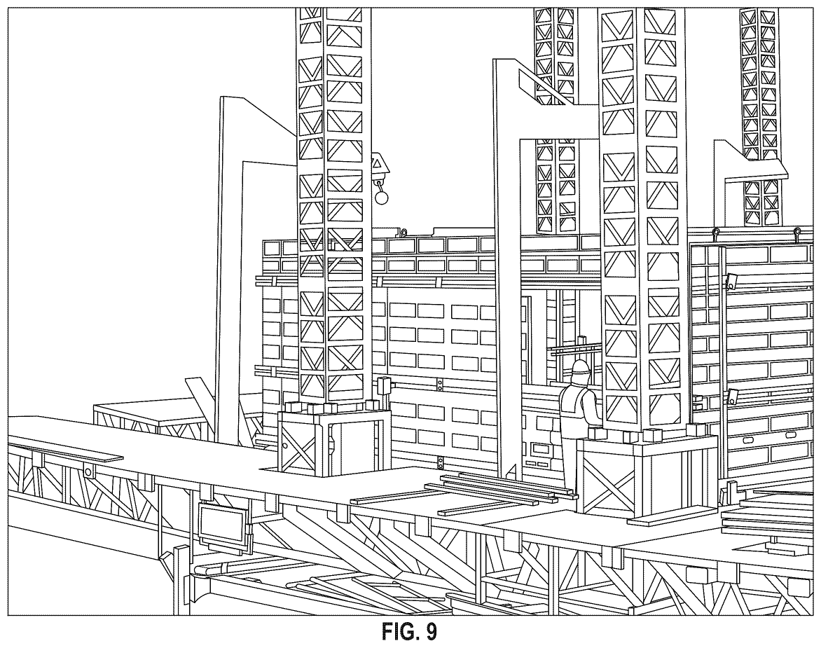

As seen in the further example embodiment of FIG. 9, the use of standardized modules also enables a great many design choices that would otherwise not be available, for example, an aluminum form system admits to efficient, economic construction of vertically supported buildings comprising concrete walls. Such metal forms may correspond to each building block. In one embodiment, when concrete-walled, standardized buildings are constructed, modular prefabricated insulated exterior panels comprising various finishes, reducing waste, time, and labor are utilized.

In one embodiment, at the job site, the construction process may follow this method:
1. Pouring concrete into an aluminum form to create a first building block;
2. Once the concrete sets, the metal form is removed and moved to the next area to start forming the shell of the second building block. Some prefabricated components, such as electrical and drywall systems, may be already embedded in the concrete structure, which accelerates the infrastructure setup for the unit and allows for an earlier installation of prefabricated components like kitchens and bathrooms.
3. After structural shoring is removed, first prefabricated structures can be transported through a sliding door opening of an apartment and positioned at their designated locations within the apartment.
4. Prefabricated plumbing and electrical systems, which were installed on-site during the concrete pouring phase, may then be connected to the prefabricated bathrooms, kitchens, and wall components to complete the first building block.
5. Concrete shells for the other building blocks may be sequentially executed. Preferably, this allows the same prefabricated installation process to take place in these subsequent blocks, thereby speeding up the overall completion of the building.

By means of the construction production system disclosed herein, construction schedules are greatly accelerated. In one embodiment, the construction schedule is reduced by approximately fifty percent. Similarly, the required labor force is also greatly reduced; in one example embodiment, labor personnel is reduced by approximately forty percent. Ordinarily skilled artisan will appreciate, however, that despite the specifics in the above example, greater or lesser results will also be achieved, especially as a particular project matures and the site is fully understood from a construction perspective.

In short, the systems disclosed herein allow for faster, safer, more reliably efficient construction; reduced labor; consistent quality; and concurrent work at both a remote facility and on the job site. The methods disclosed herein also admit to cost and scheduling assurance; reduced waste; improved safety; and reduced delays and fewer change orders.

The present invention depicted and described herein details several example embodiments. However, ordinarily skilled artisans in the relevant fields will readily appreciate that minor changes to the description and various other modifications, omissions, and additions are possible without departing from the scope or spirit or scope of the instant disclosure.

What is claimed is:

1. A method of building construction comprising:
selecting a parcel of land;
creating a site plan for one or more buildings on the parcel of land by generating a test-fit of the location, footprint, and number of floors of the one or more buildings;
creating a floor plan for the one or more buildings comprised of at least a first building block and a second building block, wherein each said building block comprises at least one apartment and at least one common area;
providing a first prefabricated structure comprising a plumbing or electrical component for the first building block;
providing a second prefabricated structure comprising a plumbing or electrical component for the second building block;
providing a first metal form corresponding to the first building block at a location corresponding to the first building block on the site plan and the floor plan;
pouring concrete in the first metal form to create the first building block on site;
removing the first metal form;
transporting the first prefabricated structure through an opening in the first building block and into a location corresponding to the floor plan;
connecting the plumbing or electrical component of the first prefabricated structure to a plumbing or electrical component of the first building block on site;
providing a second metal form corresponding to the second building block at a location corresponding to the second building block on the site plan and floor plan;
pouring concrete in the second metal form to create the second building block;
removing the second metal form;
transporting the second prefabricated structure through an opening in the second building block and into a location corresponding to the floor plan; and
connecting the plumbing or electrical component of the second prefabricated structure to a plumbing or electrical component of the second building block on site.

2. The method according to claim 1 wherein the first prefabricated structure is a bathroom.

3. The method according to claim 1 wherein the first prefabricated structure is a kitchen.

4. The method according to claim 1 wherein the first prefabricated structure is an electrical system or a plumbing system.

5. The method according to claim 1 wherein the first building block comprises at least three apartments and at least one common area.

6. The method according to claim 1 wherein the first prefabricated structure is slid through the opening in the first building block.

7. The method according to claim 1 further comprising the step of installing a plurality of prefabricated insulated exterior panels to an exterior of the first building block and the second building block.

8. The method according to claim 1 wherein one floor of the one or more buildings is a building plate, and wherein the building plate is comprised of the first building block and the second building block.

9. The method according to claim 1 wherein the first metal form is different from the second metal form.

10. The method according claim 1 further comprising the steps of:
providing a third prefabricated structure selected from the group consisting of: (i) a bathroom, (ii) a kitchen, (iii) a bedroom, (iv) a closet, (v) a mechanical system, (vi) an electrical system, (vii) a fire protection system, (viii) a sanitation unit, (ix) a plumbing system, (x) a drainage system, and (xi) a prefabricated interior wall; and
transporting the third prefabricated structure through an opening in the first building block and into a location corresponding to the floor plan.
